(19) United States
(12) Patent Application Publication
(10) Pub. No.: US 2026/0154570 A1
(43) Pub. Date: Jun. 4, 2026

(54) MEMORY EFFICIENT APPROXIMATION OF A USAGE BASED INSURANCE MODEL FOR IN-VEHICLE IMPLEMENTATION

(71) Applicant: FORD GLOBAL TECHNOLOGIES, LLC, Dearborn, MI (US)

(72) Inventors: Anuj PAL, St. Paul, MN (US); David Michael HERMAN, West Bloomfield, MI (US)

(21) Appl. No.: 18/965,333

(22) Filed: Dec. 2, 2024

(51) Int. Cl. G06N 5/022; G06Q 40/08

(52) U.S. Cl. CPC G06N 5/022; G06Q 40/08

(57) ABSTRACT

A vehicle system comprising computing devices configured to generate an insurance risk assessment using a Sparse Gaussian Process Regression (SGPR) model. The SGPR model processes aggregated vehicle signals to provide memory-efficient and computationally optimized on-vehicle risk estimation. The system detects high-uncertainty events in model predictions based on variance thresholds and either updates the SGPR model locally or selectively transmits sparse data representations to an external usage-based insurance (UBI) server, reducing data transfer costs and preserving privacy.

### TECHNICAL FIELD

This disclosure generally relates to usage-based insurance (UBI) systems, and more particularly, to the development and deployment of memory-efficient probabilistic models, such as Sparse Gaussian Process Regression (SGPR), for in-vehicle estimation of insurance costs. The disclosed technology addresses challenges associated with data transfer costs and privacy concerns by implementing UBI models directly on vehicles to optimize data usage and enhance operational efficiency.

### BACKGROUND

In connected vehicles, traditional usage-based insurance (UBI) systems typically involve transferring large volumes of driving data to cloud servers, where it is analyzed to derive insights on driver behavior and calculate insurance rates. As data accumulates across millions of connected vehicles, this approach incurs substantial data transfer costs, straining network resources and raising significant privacy concerns, given the sensitive nature of driving behavior data.

Traditional UBI models also depend on collecting low-level vehicle signals from onboard diagnostics systems or telematics control units (TCUs) to track driver behavior and update insurance rates. These models operate by continuously sending raw data to cloud-based systems for analysis, which increases data transfer costs and may expose the system to privacy vulnerabilities. Additionally, the reliance on raw data transfer may introduce noise and inconsistencies, as real-world driving conditions often vary widely.

### SUMMARY

In one configuration, the present disclosure is directed to a vehicle system including one or more computing devices configured to generate an insurance risk assessment using an in-vehicle Sparse Gaussian Process Regression (SGPR) model. The SGPR model reduces computational complexity and memory requirements by approximating Gaussian Process Regression (GPR) through the use of inducing points, where a smaller subset of representative data, denoted as M, is used in place of the full dataset size N, with M<<N. This enables the SGPR model to operate efficiently in a resource-constrained vehicle environment, achieving computational complexity of O(NM²) and memory requirements of O(M²), compared to the O(N³) and O(N²) demands of conventional GPR.

The system aggregates low-level signals from vehicle sensors, such as speed, acceleration, braking, and environmental data, to generate the insurance risk assessment. High-uncertainty events in the model predictions are detected by evaluating the variance in SGPR outputs, where high variance signifies low confidence in the model's prediction. Upon detecting such events, the system either updates the SGPR model locally using incremental learning or selectively transmits sparse representations of data, including inducing points, to an external usage-based insurance (UBI) server. This selective transmission reduces data transfer costs and preserves user privacy by avoiding the need to send raw or full-resolution driving data to the server.

The system may also include a tamper-detection module to ensure the integrity of the SGPR model. This module compares model predictions against encoded test vectors with known expected results. If discrepancies between the predicted and expected outputs exceed a predefined error threshold, a warning may be issued, ensuring that unauthorized modifications or inaccuracies in the model are promptly identified. To further increase the system's reliability, safeguards may be implemented to ensure the integrity of input data and data transmission. Input data collected from vehicle sensors, such as speed, acceleration, braking patterns, GPS coordinates, and environmental conditions, may undergo preprocessing and validation to filter out corrupted or anomalous signals. This preprocessing helps to maintain that only high-quality data is used for model predictions. Additionally, data transmitted between the vehicle and the OEM cloud may be secured using encryption protocols to prevent unauthorized interception or tampering during transmission. Measures such as checksum validation, error correction techniques, and secure data channels may be employed to verify the integrity and authenticity of transmitted data.

In another configuration, the present disclosure is directed to a non-transitory computer-readable medium comprising instructions that, when executed by one or more computing devices, cause the computing devices to implement an SGPR model for on-vehicle insurance risk assessment. The instructions include operations to: (1) aggregate low-level signals from vehicle sensors; (2) generate an insurance risk assessment using the SGPR model, wherein inducing points are used to achieve memory and computational efficiency; (3) detect high-uncertainty events by evaluating the variance of SGPR predictions; and (4) either update the SGPR model locally through incremental learning or transmit sparse data representations, such as inducing points, to an external server when such events occur. The instructions further include operations to verify the model's integrity using tamper-detection techniques, where encoded test vectors are compared against predicted outputs to identify potential errors or unauthorized modifications.

The instructions may also include functionality for incremental updates to the SGPR model, where the model may be retrained locally using new driving data to refine predictions. For instance, when the variance of model predictions exceeds a predefined threshold, the system initiates a one-step training process using recently collected data. Additionally, the instructions may facilitate transfer learning, enabling the SGPR model to adapt to different driving environments, such as urban or rural settings, or seasonal variations in road conditions.

In yet another configuration, the present disclosure is directed to a method for on-vehicle insurance risk estimation. The method may include aggregating low-level signals from vehicle controllers, such as braking patterns, acceleration, environmental conditions, and route data. These signals may also be processed using a Sparse Gaussian Process Regression (SGPR) model to generate an insurance risk assessment. The SGPR model may reduce computational demands by leveraging inducing points, allowing it to operate within the limited processing and memory resources of a vehicle's computing system.

The method may further include detecting high-uncertainty events in the SGPR model predictions. High-uncertainty events are identified by evaluating the variance of predictions, which indicates the model's confidence in its outputs. When such events are detected, the method includes selectively transmitting sparse data representations to an external UBI server. These sparse representations may include inducing points or key features of the original driving data that retain the essential characteristics needed for further analysis. Alternatively, the method may include locally updating the SGPR model using incremental learning, where newly aggregated vehicle data may be incorporated into the model to increase its accuracy and relevance to current driving conditions.

The method may also include verifying the SGPR model's integrity using a tamper-detection process. Encoded test vectors with known expected outputs are periodically processed through the SGPR model, and discrepancies between predicted and expected results are compared against a predefined error threshold. If the discrepancies exceed this threshold, a warning may be triggered, alerting the system to potential tampering or inaccuracies in the model.

Additional embodiments of the method include incremental updates to the SGPR model when high-uncertainty events are detected, enabling the model to adapt dynamically to localized driving conditions. For example, the SGPR model may update its inducing points or retrain on new data collected during specific events, such as sudden changes in driving patterns or road conditions. The method may also support transfer learning, allowing the SGPR model to adapt to diverse driving environments, such as highways, city streets, or off-road scenarios, as well as environmental factors like weather and traffic density.

Embodiments of the vehicle system, computer-readable medium, and method may also include mechanisms to prioritize data privacy and minimize resource usage. For example, the SGPR model may enable efficient storage and processing by reducing the size of the data to a sparse representation. This may not only lower computational and memory demands but also may ensure that sensitive user data remains localized on the vehicle. By transmitting only selected data, such as inducing points, to external servers, the system may reduce the likelihood of exposing sensitive driving behavior or personal information, aligning with privacy regulations and user expectations.

The present disclosure also contemplates a tamper-resistant architecture for the SGPR model, ensuring that the insurance risk assessments remain accurate and reliable. By incorporating encoded test vectors and error thresholds into the system, the model's predictions may be continuously validated against known benchmarks. This feature may provide an additional layer of security, preventing unauthorized modifications or corruptions of the model that could compromise its operation or the resulting insurance cost estimations.

### BRIEF DESCRIPTION OF THE DRAWINGS

FIG. 1 is a vehicle implementation diagram of a Sparse Gaussian Process Regression system;

FIG. 2 is a flow chart showing the implementation of a memory-efficient usage-based insurance model in vehicle; and

FIG. 3 illustrates an example computing device for implementation of a memory-efficient usage-based insurance model in vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure relates to an innovative approach to usage-based insurance (UBI) models for vehicle-based insurance cost estimation, addressing limitations in existing cloud-based data handling. Currently, vehicle data is transferred from insured vehicles to a centralized cloud server where driving patterns are analyzed to determine insurance rates. While effective, this approach involves significant costs for data transfer and raises privacy concerns due to the sensitive nature of driver behavior data. The proposed invention overcomes these challenges by implementing a simplified, memory-efficient UBI model that resides directly on the vehicle, thus reducing the need for data transfer and preserving data privacy.

This on-vehicle UBI model utilizes a Sparse Gaussian Process Regression (SGPR) model, designed to approximate the computationally intensive Gaussian Process Regression (GPR) used in conventional UBI models. By reducing the data volume through “inducing points,” the SGPR model maintains the accuracy of risk assessments with lower memory and computational demands. Specifically, while full Gaussian Process models have high computational and memory requirements, scaling as O(N³) and O(N²) respectively (where N is the number of data points), the SGPR model approximates this distribution with a smaller subset, called inducing points, denoted as M (where M<<N). With SGPR, computational complexity is reduced to O(NM²) and the memory usage to O(M²), thereby balancing model accuracy with resource efficiency. This memory-efficient model enhances interpretability, aligns predictions closely with training data, and enables localized data handling on each vehicle. In addition to privacy and cost benefits, the invention's architecture supports real-time model updates based on driving conditions, enables transfer learning for situational adaptability, and integrates methods to detect potential tampering, thereby ensuring reliable insurance estimation for various driving environments.

The vehicle implementation of the SGPR model introduces several key functionalities to address the challenges of data handling, model reliability, and adaptability. The SGPR model deployed on the vehicle can detect high-uncertainty events by evaluating the variance of its predictions. High variance indicates low confidence, often suggesting that the current data deviates significantly from the training data distribution. In such cases, the vehicle can flag these events for further processing, either by updating the model locally or by selectively transferring the raw data to the cloud for further analysis. This localized model operation minimizes the need for frequent data transfer to the cloud, contributing to lower data transfer costs and enhanced privacy protection.

Data sparsification is another key component of the SGPR model's implementation. The SGPR model condenses data into a sparse representation, allowing the vehicle to store and process data efficiently. When high-uncertainty events occur, rather than transferring a large volume of raw data, the vehicle transmits only the sparse representations or key representative points to the cloud, which reduces storage requirements and enables efficient cloud processing. Furthermore, the model incorporates a predictive accuracy check using encoded test vectors, which are periodically compared against expected model outputs. If discrepancies exceed a set threshold, a warning is triggered, indicating potential tampering or model inaccuracies.

The offline development process of the SGPR model begins with generating a large number of samples from the standard UBI model, followed by constructing a Gaussian Process model to capture the distribution patterns in driving behavior data. Due to the computational intensity of this process, it is performed offline using the full dataset. The SGPR model is then created by approximating the full Gaussian Process with a reduced number of inducing points, retaining essential data distribution characteristics while achieving computational efficiency suitable for on-vehicle deployment.

The SGPR model further supports adaptive functionalities such as online and delayed model updates. When the vehicle encounters high-uncertainty data, it can execute a “one-step training” update, allowing the SGPR model to refine its predictions based on new data. This adaptive feature enables the model to remain accurate in real-time driving conditions. Additionally, transfer learning enhances the model's ability to adapt to different driving environments, such as seasonal changes or varied urban and rural landscapes. By learning localized driving patterns, the model continually improves the relevance of its predictions, providing more accurate insurance risk assessments.

Finally, to maintain the model's security and reliability, the SGPR model includes a method for detecting tampering. This tamper-detection approach involves running encoded test vectors through the model and comparing the predicted outputs with known expected results. If the error exceeds a predefined threshold, a warning is issued, protecting against unauthorized modifications that could compromise insurance estimates. This tamper-resistant design, combined with the model's ability to adapt through transfer learning and its memory-efficient architecture, distinguishes the SGPR-based UBI model as a highly effective solution for vehicle-based insurance cost estimation.

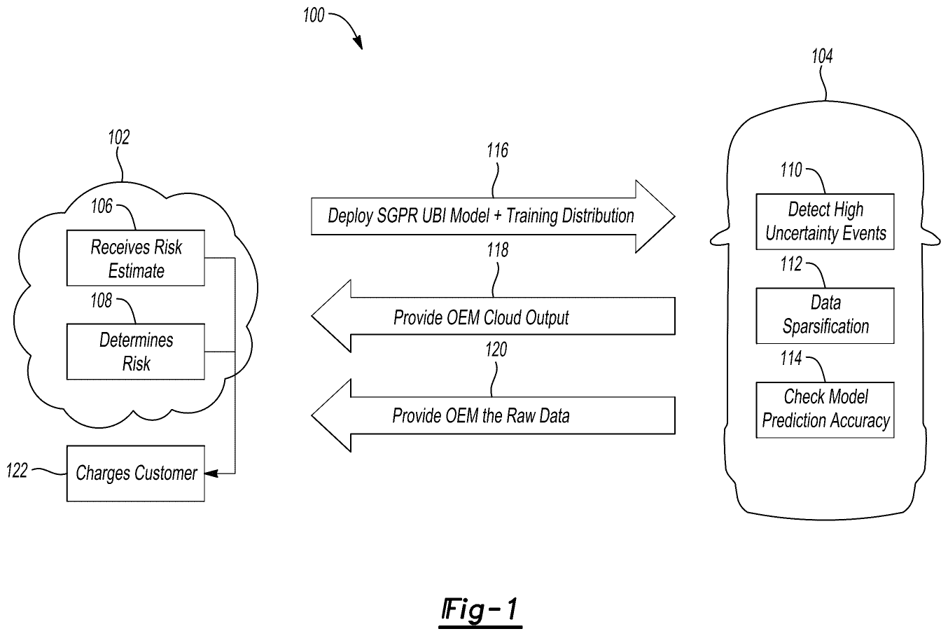

FIG. 1 is a vehicle implementation diagram 100 of a SGPR system showing the interaction between an OEM cloud 102 and a vehicle 104. Within the OEM cloud 102, there are two primary functions: a “Receives risk estimate” module 106 and a “Determines risk” module 108. These modules collaborate to assess and calculate insurance risks and are connected to a “Charges customer” component 122, responsible for billing based on the risk assessments.

The vehicle 104 includes three functional blocks: a “Detect high uncertainty events” module 110, a “Data sparsification” module 112, and a “Check model prediction accuracy” module 114. The “Detect high uncertainty events” module 110 evaluates the SGPR model's confidence by analyzing variance in its predictions. High variance indicates deviations in driving conditions or behaviors compared to the training data, triggering further data processing. The “Data sparsification” module 112 condenses raw data into a compact format, retaining only essential features to optimize memory and computational efficiency. Meanwhile, the “Check model prediction accuracy” module 114 validates the model's output against encoded test vectors, ensuring alignment with expected performance metrics and detecting potential inaccuracies or tampering.

FIG. 1 shows four primary data flows between the OEM cloud and vehicle components. The first flow 116 represents the deployment of the SGPR model and its associated training distribution from the cloud to the vehicle, enabling localized operation. This includes pre-trained parameters optimized for handling standard driving scenarios. The second flow 118 represents a feedback loop where the vehicle transmits model outputs back to the cloud. These outputs provide insights into risk assessments and are aggregated in the cloud to refine the SGPR model for broader deployment. The third flow 120 occurs under conditions of high uncertainty or when the vehicle encounters sparse data distributions outside the training dataset. In such cases, raw data—such as unusual road conditions, rare environmental factors, or atypical driving behaviors—is selectively transmitted to the cloud for further analysis and model updates. Finally, these data flows enable the system to charge the customer via the “Charges customer” component 122, completing the operational cycle.

The vehicle collects various low-level signals to support these processes, such as speed, acceleration, braking patterns, steering angles, GPS coordinates, environmental conditions (e.g., temperature and road surface quality), engine torque, and tire pressure. These signals serve as critical inputs to the SGPR model, enabling real-time risk assessments and accurate insurance cost updates. The SGPR system's architecture minimizes data transfer and enhances privacy by processing the majority of data locally on the vehicle. Furthermore, the integration of these components supports dynamic adaptability, balancing computational efficiency with robust, real-time decision-making.

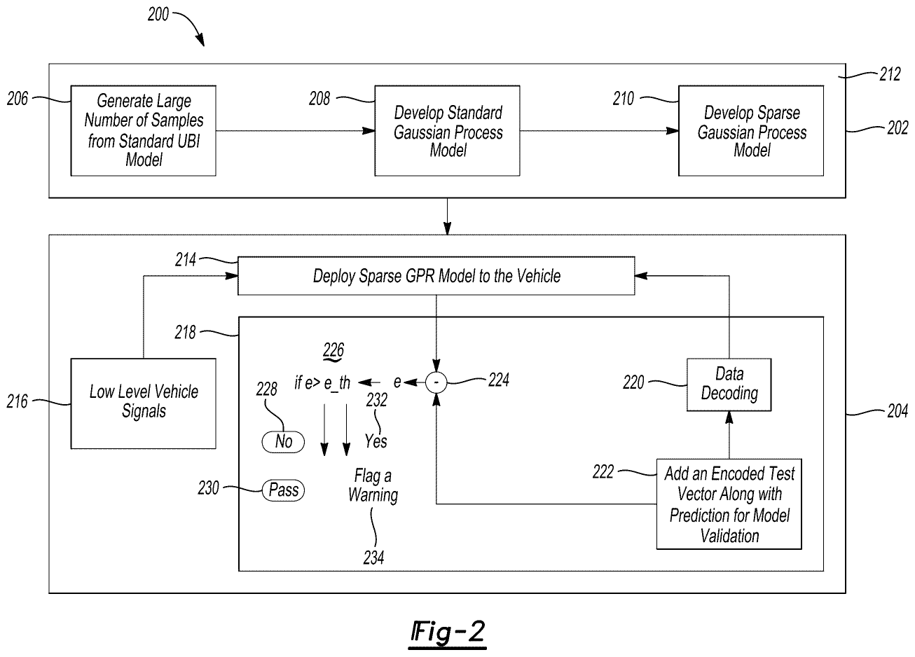

FIG. 2 is a flow chart 200 illustrating the implementation of a memory-efficient UBI model using a SGPR system. The process is divided into two phases: an offline model development phase 202 and a vehicle deployment phase 204, working together to achieve accurate, resource-efficient, and secure risk estimation in real time.

The offline model development phase 202 focuses on constructing the SGPR model to reduce the computational and memory burden typically associated with full Gaussian Process Regression (GPR) models. This phase begins with a sample generation module 206, which produces a large dataset of driving behaviors by sampling from a standard UBI model. This dataset reflects various conditions, including typical driving patterns, rare or high-risk behaviors, and environmental factors like weather or road types. The samples are fed into a Gaussian process development module 208, which creates a comprehensive GPR model. This model captures the full statistical distribution of the data but is computationally intensive, requiring high memory and processing power. To address these challenges, the sparse model generation module 210 reduces the full GPR model into a lightweight SGPR model by selecting key inducing points that approximate the original data distribution. This approach ensures the resulting model is efficient enough for deployment on vehicles with limited computational resources while maintaining predictive accuracy.

The vehicle deployment phase 204 begins with the deployment of the SGPR model 214 to the vehicle, enabling localized processing of driving data. Within this phase, a low-level signal collection module 216 gathers real-time data from the vehicle's sensors and systems. These low-level signals may include metrics such as vehicle speed, acceleration, braking patterns, steering angles, and GPS coordinates, as well as external environmental data like temperature, road surface conditions, and weather. Advanced sensor inputs, such as radar, LIDAR, and camera feeds, may also contribute to the collected data, enabling a holistic understanding of driving conditions. Additionally, perception output computed from sensor input such as lane detection, object classification, obstacle proximity, and road edge detection, may further increase the system's awareness of the driving environment. Engine performance metrics, including torque, fuel efficiency, and tire pressure, further refine the input data, allowing the SGPR model to provide granular and accurate risk assessments. This localized approach eliminates the need for constant data uploads to a centralized cloud, preserving driver privacy and reducing data transmission costs.

To ensure the integrity of the SGPR model and its predictions, the deployment phase includes a robust tamper-detection process 218. This process begins with a data decoding module 220, which decodes incoming test data used for model validation. The encoded test vector module 222 periodically runs pre-generated test vectors through the SGPR model to verify its accuracy and performance. The comparison module 224 calculates the error (e) between the model's predicted outputs and the expected results derived from the test vectors. This error is then compared to a predefined threshold (eth) by the error threshold comparison 226. If the error is within the threshold (e≤eth), the system follows the “No” path 228, indicating a pass via the pass indicator 230, and the model is deemed to be functioning as expected. However, if the error exceeds the threshold (e>eth), the system follows the “Yes” path 232, raising a warning flag 234. This warning indicates potential tampering or model inconsistencies, prompting further investigation or recalibration.

The integration of the SGPR model with the vehicle's sensors and tamper-detection mechanisms creates a robust system for real-time risk estimation and insurance cost updates. The vehicle collects and processes low-level signals to adapt to dynamic driving conditions, detecting high-risk scenarios such as sudden braking, aggressive acceleration, or deviations from typical steering patterns. For example, a combination of GPS data, steering angles, and speed changes may indicate sharp turns on slippery roads, which the SGPR model could flag as high-risk behavior. By localizing the majority of the computations to the vehicle, the system minimizes reliance on cloud processing while maintaining the ability to transmit raw data selectively in rare, high-uncertainty scenarios.

The workflow illustrated in FIG. 2 ensures a balance between computational efficiency, data privacy, and accuracy. The offline development phase optimizes the model for real-world deployment, while the vehicle deployment phase enables real-time adaptability through continuous low-level signal processing. The tamper-detection process adds a critical layer of security, ensuring that the SGPR model remains unaltered and reliable. This architecture distinguishes the SGPR-based UBI model as a scalable and privacy-preserving solution for modern vehicles, capable of delivering dynamic, memory-efficient, and accurate insurance assessments in diverse driving environments.

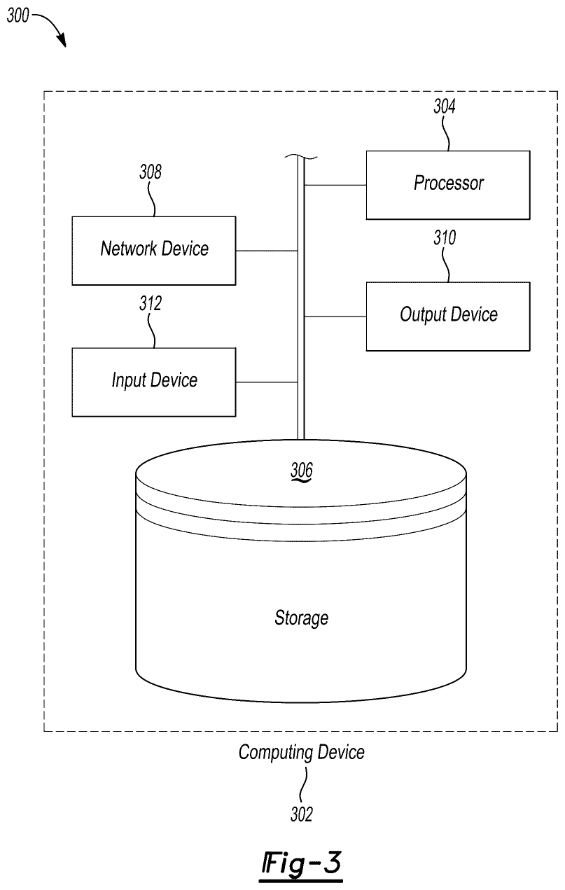

FIG. 3 illustrates a schematic diagram 300 of a computing device 302 configured to implement a memory-efficient UBI model using SGPR. The computing device 302 is shown as a unified system enclosed within a dashed border, comprising several key components interconnected through a central connection structure.

The system includes a processor 304 capable of executing the SGPR algorithms, which may be implemented as a CPU, GPU, or System on Chip (SoC). The processor 304 is designed to handle complex computations required for the UBI model, including processing vehicle signals, generating drive characteristic probability distributions (CPDs), and detecting deviations from nominal CPDs.

A storage component 306 is depicted as a cylindrical database structure, representing both volatile (RAM) and non-volatile memory (including NOR and NAND flash memory). This storage component maintains the SGPR model parameters, training distributions, and temporary computational data required for the UBI calculations.

A network device 308 is included for enabling communication with external systems, supporting various protocols such as Ethernet, Wi-Fi, cellular, Bluetooth, BLE, and UWB. This component is crucial for transmitting CPD updates to the UBI server and receiving model updates from the cloud infrastructure.

An output device 310 is shown, which can include visual displays or other interfaces for presenting insurance risk assessments and model performance metrics to operators. This component enables monitoring of the SGPR model's behavior and verification of its predictions.

An input device 312 is incorporated to allow operator interaction with the system, enabling configuration of the SGPR model parameters, threshold adjustments, and other operational controls. This can include various human interface devices such as keyboards, touchscreens, or other control interfaces.

The entire system is designed to operate efficiently within a vehicle environment, maintaining data privacy while providing accurate insurance risk assessments through the SGPR model implementation. All components are interconnected through a central connection structure, enabling seamless data flow and system integration.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle system comprising:
one or more computing devices configured to:
aggregate low-level signals from vehicle sensors;
generate an insurance risk assessment using a Sparse Gaussian Process Regression (SGPR) model, wherein the SGPR model reduces computational complexity and memory requirements by approximating Gaussian Process Regression (GPR) using inducing points; and
update the SGPR model locally based on new driving data and transmit sparse representations of the insurance risk assessment to an external usage-based insurance (UBI) server when high-uncertainty events are detected.

2. The vehicle system of claim 1 wherein the SGPR model reduces computational complexity from O(N³) to O(NM²) and memory requirements from O(N²) to O(M²), where M<<N, N is a number of data points, and M is a number of inducing points.

3. The vehicle system of claim 1 wherein the computing devices are further configured to detect high-uncertainty events by evaluating variance in SGPR model predictions.

4. The vehicle system of claim 3 wherein high-uncertainty events trigger selective transmission of sparse data to the UBI server for further analysis.

5. The vehicle system of claim 1 wherein the SGPR model is trained offline on historical driving data and deployed to a vehicle for real-time operation.

6. The vehicle system of claim 1, further comprising a tamper-detection module configured to compare SGPR model predictions against encoded test vectors to determine model integrity.

7. The vehicle system of claim 6 wherein the tamper-detection module issues a warning if discrepancies between predicted outputs and known expected results exceed a predefined threshold.

8. The vehicle system of claim 1 wherein the computing devices are configured to update SGPR model using incremental learning based on localized driving data.

9. The vehicle system of claim 8 wherein the incremental learning updates the model only when variance of predictions exceeds a predefined threshold.

10. The vehicle system of claim 1, wherein sparse representations of data include inducing points selected to retain features of original driving data.

11. A method for on-vehicle insurance risk estimation comprising:
aggregating low-level signals from vehicle sensors;
generating an insurance risk assessment using a Sparse Gaussian Process Regression (SGPR) model, wherein the SGPR model approximates Gaussian Process Regression (GPR) by using inducing points to achieve computational efficiency;
identifying high-uncertainty events based on variance of SGPR model predictions; and
selectively updating the SGPR model locally and transmitting sparse representations of data to an external server when high-uncertainty events are detected.

12. The method of claim 11 wherein the SGPR model reduces computational complexity to O(NM²) and memory requirements to O(M²) using a subset of inducing points, where M<<N, N is a number of training data points, and M is a number of inducing points.

13. The method of claim 11, further comprising training a SGPR model offline on historical data and deploying a trained model to a vehicle for real-time operation.

14. The method of claim 11, further comprising verifying integrity of the SGPR model using a tamper-detection module that compares predictions against encoded test vectors with known expected results.

15. The method of claim 14, further comprising issuing a warning if discrepancies between predicted outputs and known expected results exceed a predefined threshold.

16. The method of claim 11, further comprising updating the SGPR model incrementally when variance in predictions exceeds a predefined threshold.

17. The method of claim 16 wherein incremental updates are performed using localized driving data collected from a vehicle.

18. The method of claim 11 wherein sparse representations of data transmitted to the external server include only inducing points representing features of original data.

19. A non-transitory computer-readable medium storing instructions that, when executed by one or more computing devices, cause the computing devices to:
aggregate low-level signals from vehicle sensors;
generate an insurance risk assessment using a Sparse Gaussian Process Regression (SGPR) model, wherein the SGPR model reduces computational complexity and memory requirements by using inducing points; and
selectively transmit sparse data representations or initiate model updates based on high-uncertainty events identified through variance in SGPR model predictions.

20. The non-transitory computer-readable medium of claim 19, further comprising instructions to verify model integrity using encoded test vectors and issue warnings if prediction errors exceed a predefined threshold.
